(19) United States
(12) Patent Application Publication
(10) Pub. No.: US 2008/0013968 A1
(43) Pub. Date: Jan. 17, 2008

(54) IMAGE FORMING APPARATUS AND CONTROL METHOD FOR IMAGE FORMING APPARATUS

(75) Inventor: Takuya Kawamura, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/773,956

(22) Filed: Jul. 5, 2007

(30) Foreign Application Priority Data
Jul. 11, 2006 (JP) 2006-190545

(51) Int. Cl. G03G 15/00

(52) U.S. Cl. 399/19

(57) ABSTRACT

In an image forming apparatus capable of automatically detecting an abnormality therein, thus interrupting the operation and executing a recovery operation after the abnormal state is released, a starting position of a recovery image formation desired by a user within an object page of recovery is inputted; an address of image data, corresponding to the recovery start position input by way of the input unit is determined; and an image data corresponding to the address of the recovery image data, determined by the address determining unit, is read, and the image formation is re-started after the release of the abnormality. According to the present invention, the mage forming apparatus can achieve a saving in consumables in the recovery operation and output a recovered image with a satisfactory appearance for the user.

### BACKGROUND OF THE INVENTION

1. Field of the Invention

The present invention relates to an image forming apparatus for printing image data, and more particularly to a recovery control of an image forming apparatus having data storage.

2. Description of the Related Art

Prior image forming apparatuses execute a control called a recovery control. Such “recovery control” is a control for restoring a normal printing operation, in case of an abnormal operation, in the image forming apparatus, caused by absence of sheet and involving an interruption of image formation.

The recovery control is initiated by a release of the abnormal operation constituting the cause. In the case of absence of sheet, the abnormal operation is released by a sheet replenishment. After the abnormal operation is released, the image forming apparatus specifies an image that is to be re-printed, and automatically re-starts the printing operation, starting from the specified image.

In case of an interruption by the absence of sheet, the printing operation may be interrupted after printing the image of a specified page partways, depending on the timing of detection for absence of sheet. Such situation may arise, particularly, in case of a printer utilizing a rolled paper.

In such case, in an earlier facsimile apparatus or the like, the printing operation is executed by going back on the data corresponding to the height of the already existing image, utilizing a memory provided in the facsimile apparatus. In this manner, no deficit is formed in the image, but a joint part is formed between patched portions within the image of a page.

On the other hand, in recent composite equipment, the recovery operation is executed by designating a first page of a job or a head of a page to be recovered (for example cf. Japanese Patent Application Laid-Open No. H09-311770, paragraphs 0010 to 0011, and FIG. 15). This method allows to obtain a recovered image of a satisfactory appearance, without forming a joint part between the patched portions within the image of a page.

However, when the re-printing is executed from the start of the job or from the head of the page to be recovered, the user suffers from a waste in a recording medium such as a printing sheet and in recording materials such as an ink and a toner. Particularly in case of a large size printing printer, the image height of a page may exceed 1 meter. In such case, when the printing proceeds close to the rear end of such page until the absence of sheet is detected, an almost one page has to be printed excessively even if the re-printing is executed from the head of the page to be recovered. Owing to the recently heightened environmental concerns, some users do not like such phenomenon and request a recovery by an image patching at an interim part of the page.

However, in the aforementioned method of re-printing by going back on the data by the height of the already existing image, a joint part between the patched image portions may appear in a part important to the user within a page. This is not preferable even to the user who requests the recovery by image patching at the interim of a page. For example in case of printing a poster for use within an office, such poster may contain patched portions as it is for use only within an office, but the appearance differs greatly between a case where the joint part exists on a character of the poster and a case where the joint part exists between characters. Thus, the position of such joint part is an issue.

### SUMMARY OF THE INVENTION

Therefore, an object of the present invention is, in an image forming apparatus capable of automatically detecting an abnormality therein, thus interrupting the operation and executing a recovery operation after the abnormal state is released, to achieve a saving in consumables in the recovery operation and a recovered image output with a satisfactory appearance.

Further features of the present invention will become apparent from the following description of exemplary embodiments, with reference to the attached drawing.

### BRIEF DESCRIPTION OF THE DRAWINGS

FIG. 1 is a view of a system configuration illustrating an image forming apparatus 100 according to an exemplary embodiment 1 of the present invention.

FIG. 2 is a block diagram of the image forming apparatus 100.

FIG. 3 is a view illustrating an example of image data in the image forming apparatus 100.

FIG. 4 is a view illustrating an example of an address storage unit of a small area, in the image forming apparatus 100.

FIG. 5 is a view illustrating an example of a recovery position input unit in the image forming apparatus 100, and illustrating a panel message display in an operation unit 5.

FIG. 6 is a view illustrating an example of an image, output partways, when absence of sheet occurs in the image forming apparatus 100.

FIG. 7 is a view illustrating an output result after the recovery in the image forming apparatus 100.

FIG. 8 is a flow chart illustrating a recovery control operation in the image forming apparatus 100.

### DESCRIPTION OF THE EMBODIMENTS

A best form for executing the present invention is represented by following exemplary embodiments.

### Exemplary Embodiment 1

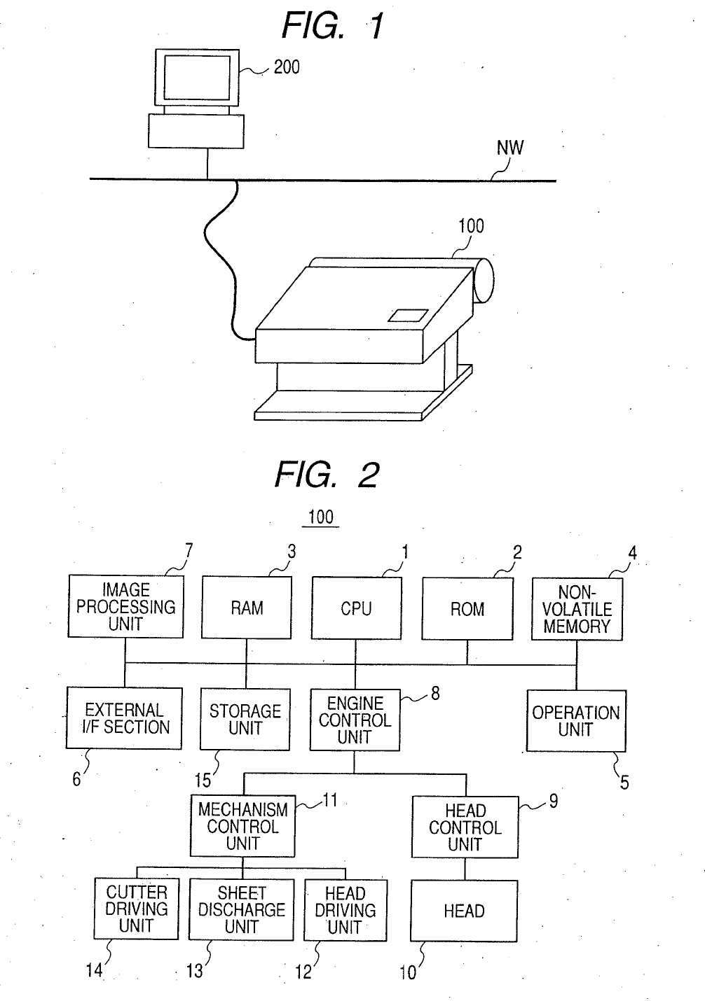

FIG. 1 is a view of a system configuration illustrating an image forming apparatus 100 in an exemplary embodiment 1 of the present invention.

The image forming apparatus 100 is a large size printing ink jet printer. The image forming apparatus 100 is connected to a LAN network NW. A host PC 200 is connected to the LAN.

The image forming apparatus 100 is a large size printing printer of an ink jet system, but the printing method may be constituted of other systems such as an electrophotographic system or a thermal sublimation system.

It may also be constructed, instead of a large size printing printer, as a desk-top printer of a cassette sheet-feeding type or a manual sheet feeding type, or as a composite copying apparatus having plural sheet feeding stages.

Also the image forming apparatus 100 is equipped, as an external I/F, with a network connection unit, but may also be connected, by USB or IEEE1394, to a print server which is separately provided.

FIG. 2 is a block diagram illustrating the image forming apparatus 100.

A CPU 1 executes control of the image forming apparatus 100 and also executes an analysis and an executions of a command from the exterior. A ROM 2 stores a program to be executed by the CPU 1.

A RAM 3 includes an image memory area for storing image data received from the exterior, and a work memory area to be used by the CPU 1 in executing the program, which are independently secured on the RAM 3.

A non-volatile memory 4 is constituted of a Flash ROM or an EEPROM. The non-volatile memory 4 stores set values such as a sheet type currently set in the image forming apparatus 100, and the stored content is not lost even if an electric power supply is interrupted.

An operation unit 5 includes an LCD, an LED and a key input apparatus. It displays a message from the CPU by the LCD and LED for observation by the user, and also transmits an instruction from the user to the CPU.

An external I/F section 6 is capable of transmission and reception by a network connection protocol such as an IP protocol.

A storage unit 15 stores image data, received from the external I/F section 6.

An image processing unit 7 reads, based on an instruction from the CPU 1, image data, received by the external I/F section 6, from a storage unit 15, and stores and develops it in the image memory area on the RAM 3. The developed data is pixel data that can be printed by an engine control block to be described later.

The engine controller 8 controls various units of the image forming apparatus and executes a printing operation.

A head controller 9 executes such a control on a printer head 10 as to execute drawing of each pixel. A mechanism control unit 11 controls a head driving unit 12, a sheet discharge unit 13 and a cutter driving unit 14, thereby executing the printing of the pixel data. A printed sheet is cut by the cutter driving unit 14, as an output sheet.

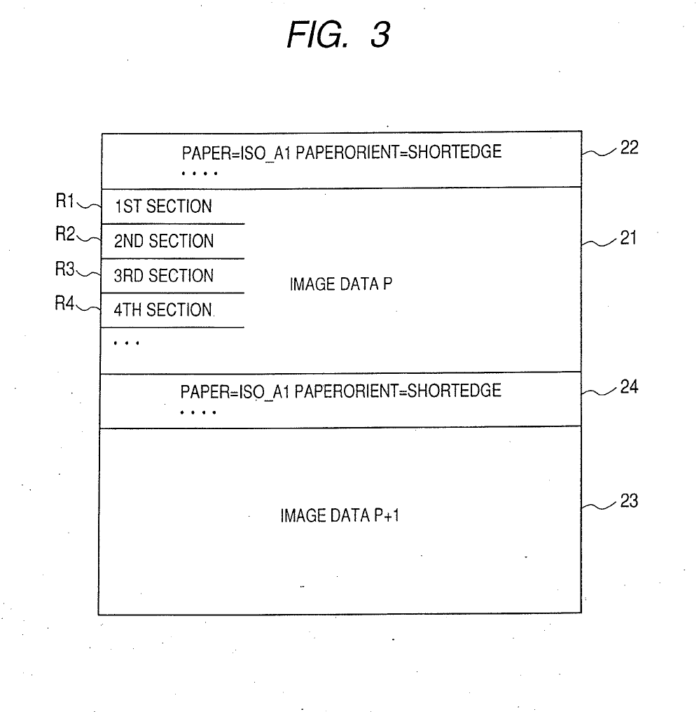

FIG. 3 illustrates an example of the image data in the image forming apparatus 100.

The image data illustrated in FIG. 3 is input from the external I/F section 6, and is stored in the storage unit 15. FIG. 3 represents a part of the image data of one job.

Image data 21 is image data of a page P, which is an object of the recovery.

Information 22 is information relating to a sheet feeding and an image formation on the image data 21 of the object page P.

Image data 23 is an image data of a page (P+1), immediately succeeding to the image data 21 of the object page P.

Information 24 is information relating to a sheet feeding and an image formation on the image data 23 of the immediately succeeding page.

Sections R1 to R4 indicate small sections formed by dividing the image data 21 of the page P, which is the object of recovery, for example in a unit of 1 mm in the conveying direction of the sheet. For example in case of 1200 dpi, the image data can be divided in a unit of 47 rasters. The first section R1 is a leading small section within the object page of recovery, which is followed in succession by a second section R2, a third section R3, and a fourth section R4. Though not illustrated in FIG. 3, fifth and subsequent sections exist in a similar manner as the first to fourth sections.

Also, though not illustrated in FIG. 3, the image data of the same job may continue after the image data 23 of the immediately succeeding page. Further, though not illustrated in FIG. 3, the image data of a page preceding the object page may also be contained in the same job.

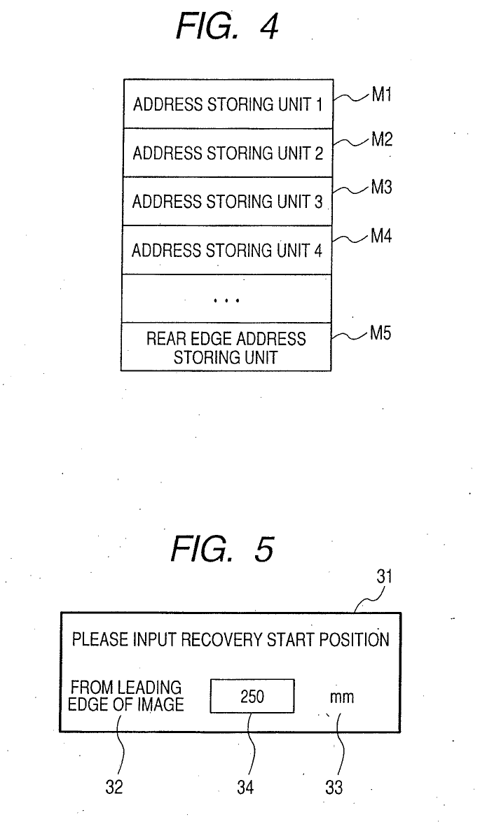

FIG. 4 illustrates an example of address storing unit for small sections in the image forming apparatus 100.

The “small sections” mentioned above mean the sections R1 to R4 illustrated in FIG. 3. An address of the section means an address of each section, formed by dividing the image data, on the image data.

The address storing unit illustrated in FIG. 4 is secured on the RAM 3, as a part of the work memory area to be used by the CPU 1 in executing the program. A memory M1 serves to store the address of the first section R1. Thereafter, M2 to M4 respectively represent memories for the second to fourth sections R2 to R4. A memory M5 stores the address of a section at the rear end of the object page.

The image forming apparatus 100 has the address storing unit, as illustrated in FIG. 4, in two units on the RAM 3, thereby constituting so-called double buffers.

Such structure is adopted in order to prepare for a case where, at a boundary between pages, the CPU 1 processes a next page while the engine control unit 8 processes a preceding page.

By constructing such address storing unit on the RAM 3, the image forming apparatus 100 is capable, at an image formation, to store and memorize addresses on the image, corresponding to the memories M1 to M5 of the address storing unit.

FIG. 5 is a view of an example of a recovery position input unit in the image forming apparatus 100, illustrating a panel message display of the operation unit 5.

A message 31 requests an input of the recovery position. A message 32 indicates a reference position and a direction for the recovery position input. A message 33 indicates a unit for the recovery position input. A display 34 indicates a numerical value of the recovery position at the recovery position input. The user can enter the numerical value of the recovery position, utilizing keys provided in the operation unit 5.

When a situation of absence of sheet is generated, the image forming apparatus 100 displays the recovery position input unit, as illustrated in FIG. 5, on the operation unit 5, thereby acquiring the recovery start position intended by the user.

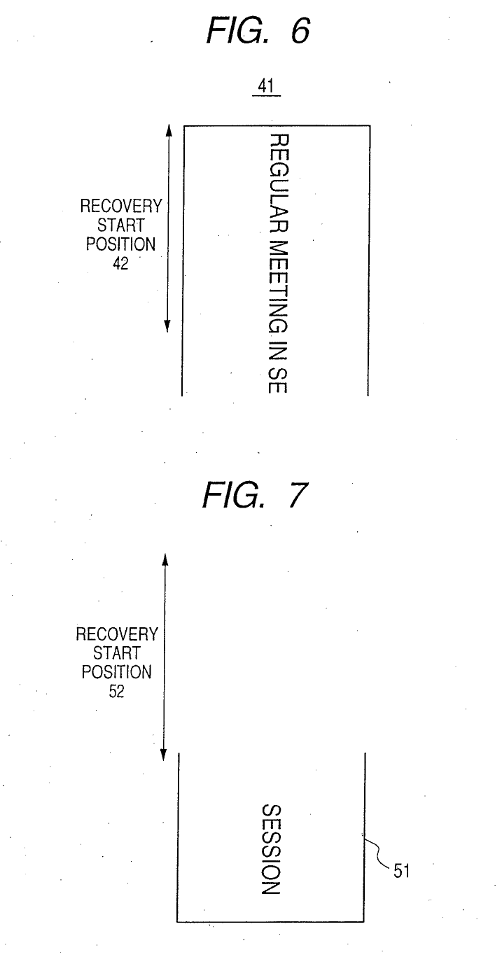

FIG. 6 illustrates an example image, output partways, when the absence of sheet is generated, in the image forming apparatus 100.

More specifically, FIG. 6 illustrates an example in which a poster, including a vertical train of words including “Regular Meeting in Session” is interrupted at the word “Session” due to the absence of sheet.

An output image 41 is an output image output to an interim part of a page. A recovery start position 42 indicates a recovery start position, intended by the user, in the image forming apparatus 100, and corresponds to the numerical value input in the display 34 in FIG. 5. This example indicates that the user intends to avoid the patching within the word “Session” and to select the patching position between the words “Meeting” and “in Session”.

FIG. 7 illustrates an output result after the recovery, in the image forming apparatus 100.

An output image 51 is output by recovery from an interim position of a page, which is the recovery position intended by the user.

A recovery start position 52 indicates a recovery start position, intended by the user, in the image forming apparatus 100, and corresponds to the numerical value input in the display 34 in FIG. 5.

As illustrated in FIGS. 6 and 7, the image forming apparatus 100 is capable of accommodating the intention of the user, for example to place the recovery start position between the words “Meeting” and “in Session” in order that the patching position does not lie on a word.

In the following, a recovery control operation in the image forming apparatus 100 will be described. Such recovery control becomes necessary in case of an abnormality where the image forming apparatus 100 is incapable of continuing the printing operation, such as a deficiency of an image forming medium such as a rolled paper, a deficiency in an image forming material such as an ink and a jamming of an image forming medium such as a rolled or cut sheet, and a recovery request to be described later is made upon detecting a release of such abnormality for example by a replenishment of the rolled paper, an ink replenishment or a removal of jamming.

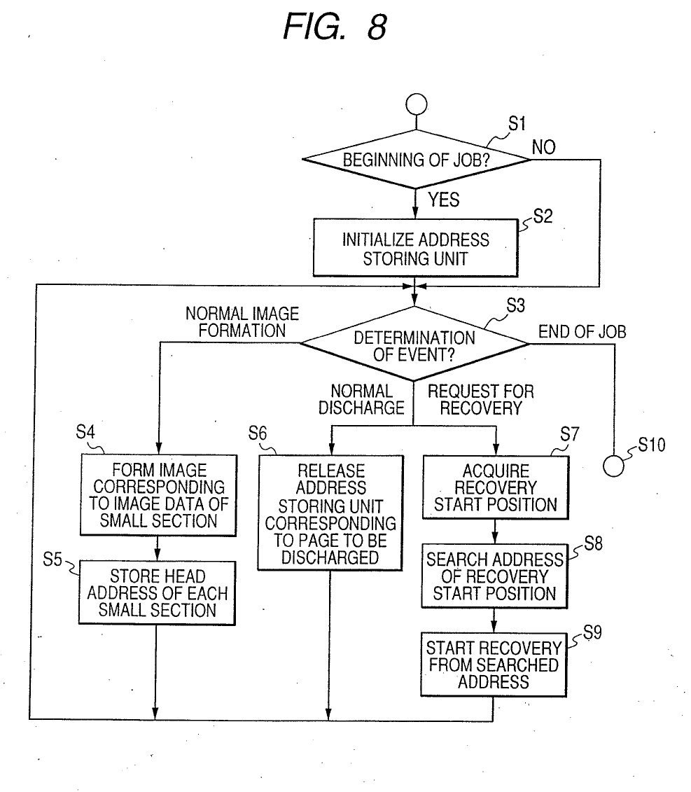

FIG. 8 is a flow chart illustrating the recovery control operation in the image forming apparatus 100.

A control corresponding to this flow chart is executed by the CPU 1. A step S1 discriminates whether it is a beginning of a job, and, if so, a step S2 initializes both of the double buffers of the address storing unit illustrated in FIG. 4.

A step S3 discriminates an event. The sequence proceeds to a step S4 in case of a normal image forming request, to a step S6 in case of a normal sheet discharge, or to a step S7 in case of a recovery request. When the job is completed, the sequence proceeds to a step S10 whereupon the flow chart is terminated.

In case of a request for an ordinary image formation, the step S4 executes an image formation for each small section. The image formation in this case is executed by developing the image data, read from the storage unit 15, on the RAM 3 for each small section for conversion into pixel data, and sending such data to the engine control unit 8 for printing. A step S5 stores a head address of the image data of the small section, subjected to the image formation in the step S4, in the address storing unit illustrated in FIG. 4, and the sequence returns to the step S3.

While the small sections of a certain page continue, the event of normal image formation continues, so that the steps S3, S4 and S5 are repeated. Then, when a normal image formation event for the data of a next page arrives, the address storing unit illustrated in FIG. 4 and constituted of double buffers is switched to the empty one for the next page.

In case of a normal sheet discharge, a step S6 releases the address storing unit, corresponding to the page to be subjected to a sheet discharge among the double buffers of the address storing unit, and then the sequence returns to the step S3.

In case of a recovery request, a step S7 displays the recovery position input unit, illustrated in FIG. 5, on the operation unit 5, thereby acquiring a recovery position intended by the user. Then a step S8 searches, in the address storing unit corresponding to the object recovery page instructed by the engine control unit 8, a recovery start position entered by the recovery position input unit illustrated in FIG. 5, and acquires an address on the image. As an example, in case of a unit of 1 mm and an input value of 250 as illustrated in FIG. 5, there is acquired a head address of a 250th small section, corresponding to a position of 250 mm from the beginning of the object page. The recovery request is made, after the generation of an aforementioned abnormality where the image forming apparatus 100 is incapable of continuing the printing operation, upon detecting that such abnormality is released.

A step S9 reads a recovery image from the storage unit 15, according to the address information searched in the step S8, the recovery is started, and the sequence returns to the step S3.

According to the exemplary embodiment described above, the recovery image formation can be initiated from a position, desired by the user, within the recovery object page, thereby achieving a saving of consumable materials in the recovery operation and a recovery image output, having a satisfactory appearance for the user, at the same time.

Also the above-described exemplary embodiment enables to shorten the time required for the recovery output, in comparison with the case of re-starting the printing from the beginning of the recovery object page while obtaining a recovery image output satisfactory in appearance to the user.

Furthermore, in the above-described exemplary embodiment, the address determining unit is provided to dispense with the necessity for storing the head addresses of all the rasters of the image data, thereby saving the memory capacity required in the image forming apparatus 100.

Furthermore, in the above-described exemplary embodiment, the address determining unit enables to derive the address for recovery without searching the image data to the recovery start position, whereby the time for recovery can be shortened.

In the image forming apparatus described above, at the image formation, the head address of the small section is stored in the address storing unit. The above-described exemplary embodiment has shown a case of absence of sheet, but this embodiment is applicable also to the recovery in the case of absence of ink or of toner and to the recovery in the case of a jamming.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-190545, filed Jul. 11, 2006, which is hereby incorporated by reference herein in its entirety.

What is claimed is:

1. An image forming apparatus capable of automatically detecting an abnormality where the image forming apparatus becomes incapable of continuing an operation, thus interrupting the operation and executing a recovery operation after the abnormal state is released, the apparatus comprising:
an input unit for inputting a starting position of a recovery image formation desired by a user within an object page of recovery;
an address determination unit for determining an address of image data, corresponding to the recovery start position input by way of the input unit; and
a recovery control unit for reading an image data corresponding to the address of the recovery image data, determined by the address determining unit, and re-starting the image formation after the release of the abnormality.

2. An image forming apparatus according to claim 1, wherein the address determining unit comprises an address storing unit for storing head addresses of small sections, formed by dividing an image within a page at a predetermined pitch in a conveying direction of a sheet.

3. An image forming apparatus according to claim 1, wherein the abnormality where the image forming apparatus becomes incapable of continuing an operation is a deficiency in an image forming medium, and the release of the abnormality is executed by a replenishment of the image forming medium.

4. An image forming apparatus according to claim 2, wherein the abnormality where the image forming apparatus becomes incapable of continuing an operation is a deficiency in an image forming medium, and the release of the abnormality is executed by a replenishment of the image forming medium.

5. An image forming apparatus according to claim 1, wherein the abnormality where the image forming apparatus becomes incapable of continuing an operation is a deficiency in an image forming material, and the release of the abnormality is executed by a replenishment of the image forming material.

6. An image forming apparatus according to claim 2, wherein the abnormality where the image forming apparatus becomes incapable of continuing an operation is a deficiency in an image forming material, and the release of the abnormality is executed by a replenishment of the image forming material.

7. An image forming apparatus according to claim 1, wherein the abnormality where the image forming apparatus becomes incapable of continuing an operation is a jamming of an image forming medium, and the release of the abnormality is executed by a removing of the jamming of the image forming medium.

8. An image forming apparatus according to claim 2, wherein the abnormality where the image forming apparatus becomes incapable of continuing an operation is a jamming of an image forming medium, and the release of the abnormality is executed by a removing of the jamming of the image forming medium.

9. A control method for an image forming apparatus capable of automatically detecting an abnormality where the image forming apparatus becomes incapable of continuing an operation, thus interrupting the operation and executing a recovery operation after the abnormal state is released, the method comprising:
determining an address of image data, corresponding to the recovery start position input by way of an input unit for inputting a starting position of a recovery image formation desired by a user within an object page of recovery; and
executing a recovery control of reading an image data corresponding to the address of the recovery image data, determined by the address determining, and re-starting the image formation after the release of the abnormality.
